(19) United States
(12) Patent Application Publication
(10) Pub. No.: US 2010/0088913 A1
(43) Pub. Date: Apr. 15, 2010

(54) Apparatus and Method for Simutaneously Functioning Internal Shaft and Plunger of a Micrometer

(76) Inventor: Dustin Edward Conlon, Westmont, IL (US)

Correspondence Address: REV DR DONALD A. WRIGHT, 1619 BOTTING BAY, MOOSE JAW, SK, S6H 7S7, CA

(21) Appl. No.: 12/252,352

(22) Filed: Oct. 15, 2008

(51) Int. Cl. G01B 5/06

(52) U.S. Cl. 33/556

(57) ABSTRACT

The base of the micrometer is made of steel (1). The base of the micrometer is attached to three rubber micrometer feet (2). The rubber micrometer feet help reduce vibrations which lead to accurate test sample measurements. Recessed in the base of the micrometer is the bottom anvil (3). Directly above the bottom anvil is the top anvil (4), which is screwed into the plunger (5). The plunger has a set screw which holds the steel shaft (6) to the plunger in order for the plunger and steel shaft to work as one unit. The steel shaft fits up inside of the brass bushing (7) which results in a tight tolerance. The micrometer frame (8) is the unit that holds all the components together. The brass bushing is pressed into the micrometer frame. The base of the micrometer is screwed to the frame with four screws. The micrometer frame stop (9) is screwed to the top of the micrometer frame with four screws. The micrometer frame stop ensures that the steel shaft does not over extend and helps keep dirt, dust, debris, and other containments out of the steel shaft of the micrometer. The micrometer handle (10) is comprised of four components. The micrometer handle is the component that rises and lowers the plunger. The side swing arms (11) are attached to the micrometer handle, one of each side, and to the micrometer frame. In the middle of the side swing arms is the location of the handle/plunger screws (12). The handle/plunger screws hold the plunger in place. Behind the plunger on the side swing arms is a stabilizer bar (13). The stabilizer bar adds to the strength of the micrometer handle. Attached to the front of the plunger is a dial rest (14). The dial rest is where the dial indicator (15) receives the readings from the test sample measurements.

### BACKGROUND OF INVENTION

1. Field of the Invention

This invention relates generally to the field of corrugated or paper industry in the use of a micrometer to measure the thickness of any paper or box which is either preprinted or prepared for printing. In addition, the invention relates to a micrometer used in the workplace in the field of paper and corrugated measurements which unlike the prior art is unaffected by dust and not requiring lubrication. The micrometer internally has a shaft and plunger, required for testing of paper thickness.

2. Description of the Related Art

There are various versions of the micrometer in current use in the corrugated and paper industry. Of all these versions, dust and other contaminants frequently disrupt the accuracy, functionality, and precision of the micrometer. The design of existing plungers in micrometers has caused extensive downtime and costly repairs, since the micrometer has been used to test samples in the corrugated and paper industry. During the production of making corrugated, printing process, and dye cutting, it is common in the current versions of a micrometer that dust will affect the functionality of the plunger. The current models require lubrication in the form of oil to circumvent this problem. The problem relating to disruption from dust and other containments can be related to dust trapped in the internal shaft of the micrometer. Inside the internal shaft of the micrometer is positioned a plunger. When the plunger moves up and down over the lubricated shaft inside of the micrometer, dust and other particles get trapped and coagulate causing a disruption of function in the lubricated shaft.

Currently, the technique for measuring the thickness of paper in a micrometer is prohibited and impeded by continual maintenance and repair due to coagulation of dust and contaminants. In addition, the internal shaft is a fixed rigid structure, where the internal plunger moves along the shaft to measure paper thickness. Furthermore, in the current art, in the micrometer, a plunger is moved directionally by a cam and pulley system.

### SUMMARY OF INVENTION

The present invention has been developed in view of the difficulties found with the aforementioned dust and maintenance problems. Therefore, it is a device and method of the present invention to provide a device and means to lower user downtime for repair, decrease affects of dust and contaminants, and provide a non-lubrication micrometer, while simultaneously provide a device and means for accurate paper and corrugated sample testing.

Without limiting the scope of the invention, a brief summary of some of the claimed embodiments of the invention is set forth below. Additional details of the summarized embodiments of the invention and/or additional embodiments of the invention may be found in the Detailed Description of the Invention below. A brief abstract of the technical disclosure in the specification is provided as well only for the purposes of complying with 37 C.F.R.1.72. The abstract is not intended to be used for interpreting the scope of the claims. All U.S. patents and applications and all other published documents mentioned anywhere in this application are incorporated herein by reference in their entirety.

One embodiment of the present invention comprises of a micrometer where the shaft and plunger move in concert, together. There are many different versions and types of micrometers, which test samples in the corrugated and paper industry. Micrometers share many similarities. Each micrometer requires two rigid durable anvils; the anvils compress the test sample to arrive at a test sample measurement. Each micrometer requires a dial face to read the test sample measurement. The distinguishing aspect of this device relates to the internal shaft and plunger. Micrometers are used in a very hostile environment; which contain continual dirt, dust, debris, and other containments. The dirt, dust, debris, and other containments build up inside the fixed shaft and internal plunger causing the existing micrometers to have a malfunction; thus resulting in down time and costly repairs. A simultaneously functioning internal shaft and plunger eliminates the damage that dir, dust, debris, and other containments. The plunger is affixed to the steel shaft. This is a result of compressing the steel shaft into the plunger. The handle plunger screws act as reinforcement to the plunger adhering to the steel shaft. The affixed internal plunger and steel shaft are then fit into a brass bushing. The plunger which is affixed to the steel shaft moves up into a brass bushing which does not allow dirt, dust, debris, and other containments to gather at the bottom of the plunger; thus keeping the shaft portion of the plunger free from dirt, dust, debris, and other containments. By creating a shaft and plunger that is free from dirt, dust, debris, and other containments ensures continual accurate test sample measurements, and eliminates downtime and costly repairs. The permissible space between the internal shaft and the brass bushing is so minimal that even dust is unable to fit between said shaft and bushing. Further, tangential requirement of the shaft and bushing serves as to deter and limit the vibrations caused by the surrounding paper manufacturing machinery, Finally, with a simultaneously functioning shaft and plunger affixed to the brass bushing, the handle of the micrometer is able to work as an additional stabilizer. The benefit of the micrometer handle working as an additional stabilizer is to enable the test sample measurements to be accurate even though the environment is hostile, due to continual movement in the testing areas.

### BRIEF DESCRIPTION OF THE DRAWINGS

FIG. 1 is an isometric view of the basic component of the base of the micrometer in accordance with embodiments of the present invention.

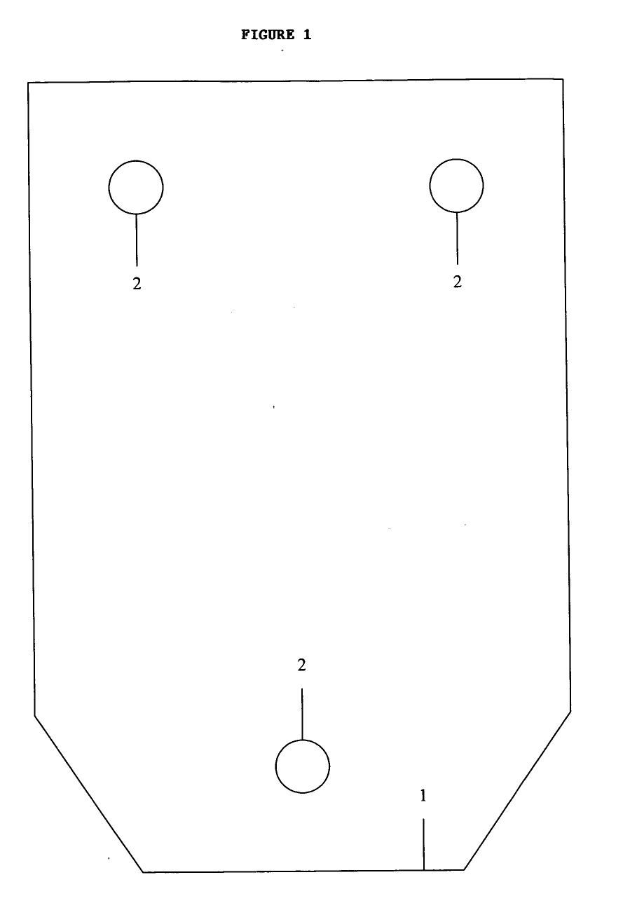

FIG. 2 is an isometric view of the base component and upper and lower anvil, along with the plunger and steel shaft in accordance with embodiments of the present invention.

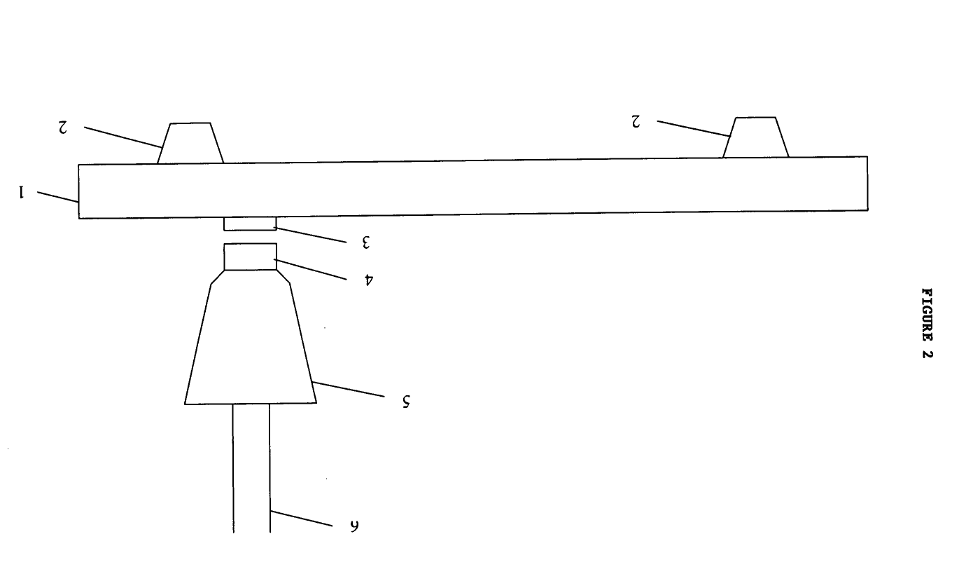

FIG. 3 is an isometric view of the brass pushing, frame and frame stop in accordance with embodiments of the present invention.

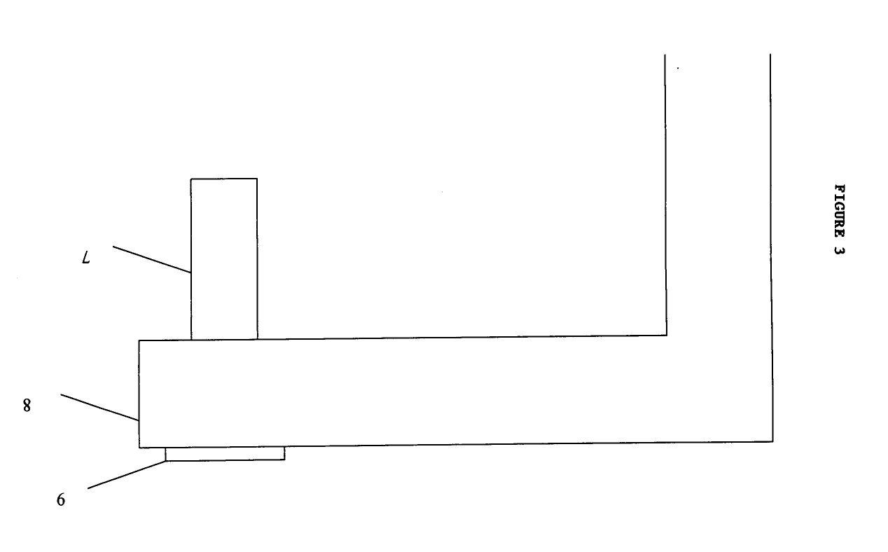

FIG. 4 is an isometric view of the micrometer handle in detail illustrating the plunger, side swing arms, handle plunger screw and stabilizer bar of embodiments of the present invention.

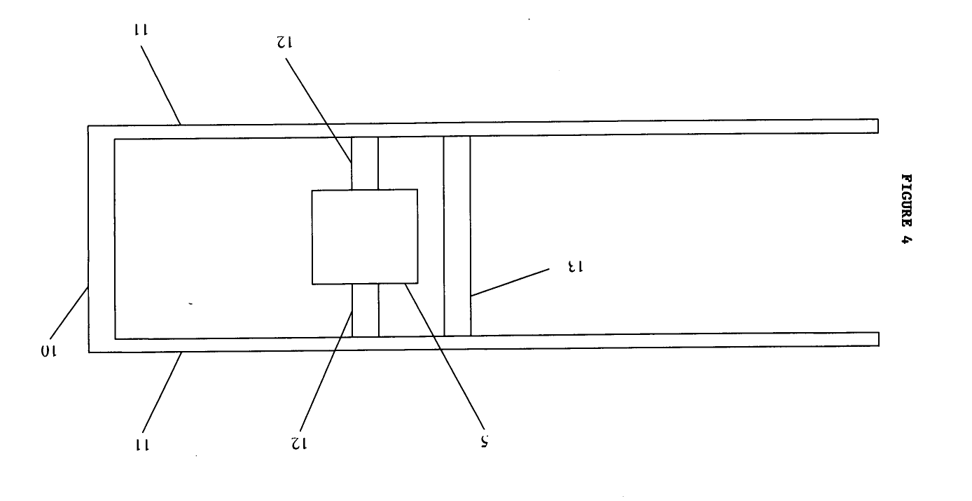

FIG. 5 is an isometric view of the basic components of a micrometer apparatus containing the addition of embodiments of the present invention.

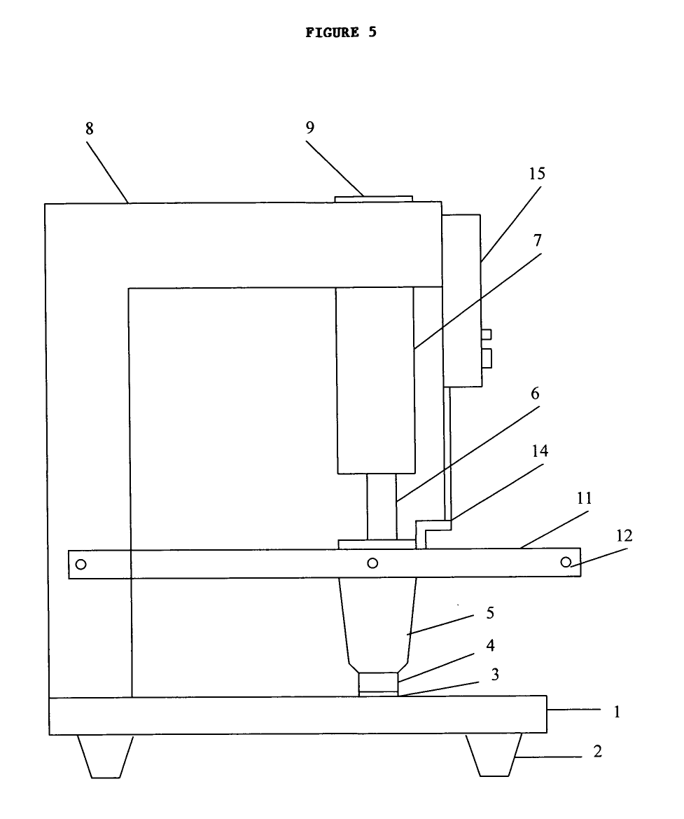

1. A micrometer comprising: a internal steel shaft, plunger, brass bushing, handle, feet, base, dial indicator, base of micrometer, micrometer feet, bottom Anvil, top anvil, micrometer frame, micrometer frame stop, side swing arms, handle screw, plunger screw, stabilization bar, dial rest, dial indicator.

2. A micrometer of claim 1, wherein the plunger and steel shaft simultaneously function after have been fused into one unit.

3. A micrometer of claim 2, wherein the steel shaft and the plunger is so that the steel shaft slides up inside of the brass bushing.

4. A micrometer of claim 2, wherein the handle is located directly in the center of the micrometer, attached to both sides of said plunger, to accommodate a left and right handed individual.

5. A micrometer of claim 2, wherein said brass bushing and said steel shaft form an enclosed unit where the brass bushing and steel shaft form a cohesive connection to prohibit dust and debris from entering said brass bushing.

6. A micrometer of claim 2, wherein the feet, which are made of rubber, is so that there is a reduction in outside movement and vibrations.

7. A micrometer of claim 2, wherein the handle connects to the micrometer frame and the plunger, allowing the plunger and steel shaft to move within the brass bushing.

8. A micrometer of claim 2, wherein the user selects and customizes a dial indicator to be placed in the front of the micrometer frame attached to a dial rest.

9. A micrometer of claim 2, wherein the frame stop is affixed to the top of the micrometer frame to prohibit the steel shaft to over extend and make contact with the dial indicator.
